(19) United States
(12) Patent Application Publication
(10) Pub. No.: US 2013/0088518 A1
(43) Pub. Date: Apr. 11, 2013

(54) METHODS AND SYSTEMS FOR PROVIDING A GRAPHICAL USER INTERFACE

(71) Applicants: Tara Lemmey, San Francisco, CA (US); Nikolay Surin, San Francisco, CA (US); Stanislav Vonog, San Francisco, CA (US)

(72) Inventors: Tara Lemmey, San Francisco, CA (US); Nikolay Surin, San Francisco, CA (US); Stanislav Vonog, San Francisco, CA (US)

(73) Assignee: Net Power and Light, Inc., San Francisco, CA (US)

(21) Appl. No.: 13/270,125

(22) Filed: Oct. 10, 2011

(51) Int. Cl. G09G 5/373

(52) U.S. Cl. 345/661

(57) ABSTRACT

The present invention contemplates a variety of improved methods and systems for providing a graphical user interface (GUI). As taught herein, the “display stack” is an elegant mechanism for managing the complexities of content, particularly in a touch screen, portable device, and/or smart phone setting where other types of human-computer interface hardware may not be readily accessible, and/or the screen may not be large relative to the amount of content involved.

### BACKGROUND OF INVENTION

1. Field of Invention

The present invention relates to human-computer interfaces, and more particularly to graphical user interfaces some of which are particularly suited for touch screen systems, portable devices, and/or smart phones.

2. Description of Related Art

The graphical user interface (GUI) is continuously evolving to keep pace with advances in hardware and software applications. On the hardware front, touch screen systems, portable devices and smart phones raise particular challenges due to factors such as available I/O and device footprint. Still further, new yet fundamental platforms within social media and networking, and interactive and pervasive computing present the GUI and application designer further challenges. On the other hand, these advances present incredible new opportunities, some apparent and some to be discovered.

### SUMMARY OF THE INVENTION

The present invention contemplates a variety of improved methods and systems for providing a graphical user interface (GUI). As taught herein, the “display stack” is an elegant mechanism for managing the complexities of content, particularly in a touch screen, portable device, and/or smart phone setting where other types of human-computer interface hardware may not be readily accessible, and/or the screen may not be large relative to the amount of content involved.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIGS. 1-16 illustrate a graphical user interface with a variety of different elements in various states of operation.

### DETAILED DESCRIPTION OF THE INVENTION

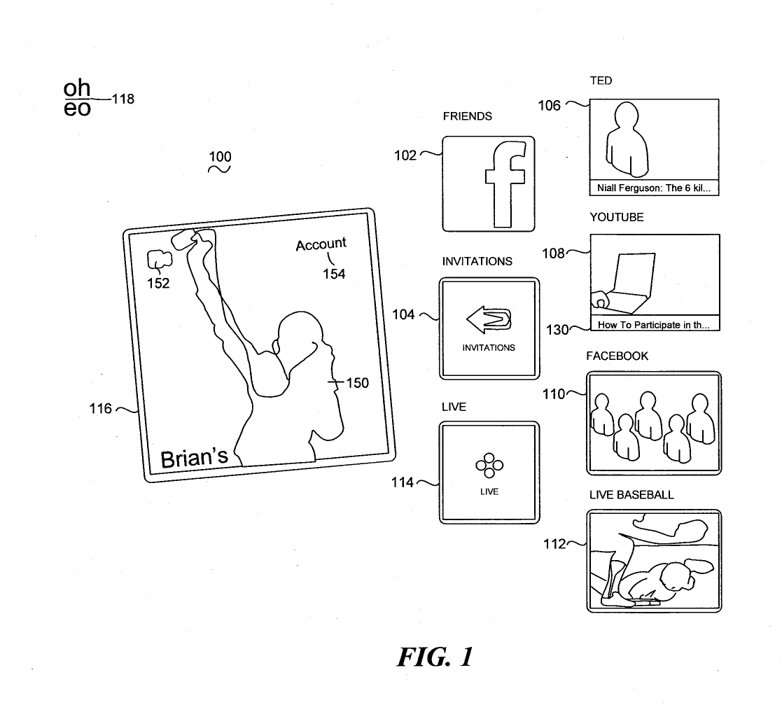

FIG. 1 illustrates a graphical user interface (GUI) 100 according to an embodiment disclosed herein. In this specific embodiment, the GUI 100 is implemented on an iPad touch screen, although any computer system is conceivably suitable. For example, other smart phones, PDAs, portable computer, netbooks, etc. would be suitable. Many of the features described herein facilitate interaction with other users and participants, often remote. In these cases, the computer system would need network capability. In any event, those skilled in the art will readily understand the necessary features of the underlying computer system based upon the particular application.

The GUI 100 includes a plurality of display stacks such as contact stack 102, an invitation stack 104, a first video content stack 106, a second video contact stack 108, a social site stack 110, and a sporting site stack 112. As taught herein, the “display stack” is an elegant mechanism for managing the complexities of content, particularly in a touch screen setting where other types of human-computer interface hardware may not be readily accessible, and/or the screen may not be large relative to the amount of content involved.

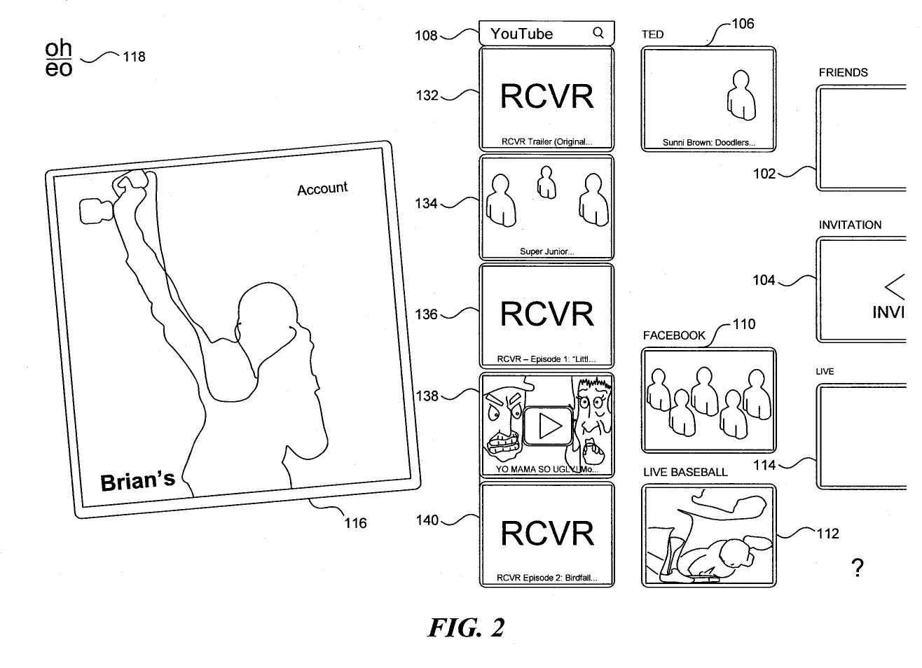

The “display stack” can take on a variety of implementations. Certain implementations of the display stack have a collapsed state and an expanded state. By way of example, the second video stack 108 is shown in FIG. 1 in a collapsed state. In contrast, the second video stack 108 is shown in FIG. 2 in an expanded state. As seen in FIG. 1, the collapsed state of the second video stack 108 is presented with a display block 130 corresponding to a specific video on top, with an appearance of a plurality of other video content display blocks stacked in a staggered manner underneath. This particular collapsed state thus provides an indication of the type of content available, as well as an indication that a plurality of content can be accessed by expanding or changing a state of the video stack 108.

With further reference to FIGS. 1-2, by a selection process, e.g. double tapping on the collapsed stack 108, the GUI 100 responds by expanding the stack 108 into a linear expanded state showing a plurality of display blocks 132-140, each corresponding to a specific video. For this particular embodiment, the GUI 100 has the additional functionality of rearranging the GUI elements in response to expanding the stack 108, the rearrangement facilitating presentation of information and interaction with the GUI. The stack 108 may also be scrollable, i.e., additional content may be accessed by scrolling up and/or down to additional display blocks. Rearranging to accommodate the GUI elements to improve usability, scrolling, searching and other possible features of the GUI are described in more detail below. Throughout the present discussion, reference may be made to one particular type of stack, or even a specific stack such as stack 108. As will be appreciated, the different GUI concepts described in one context are readily applicable to other stacks, depending of course on the desired implementation and suitability for the relevant underlying content in the stack.

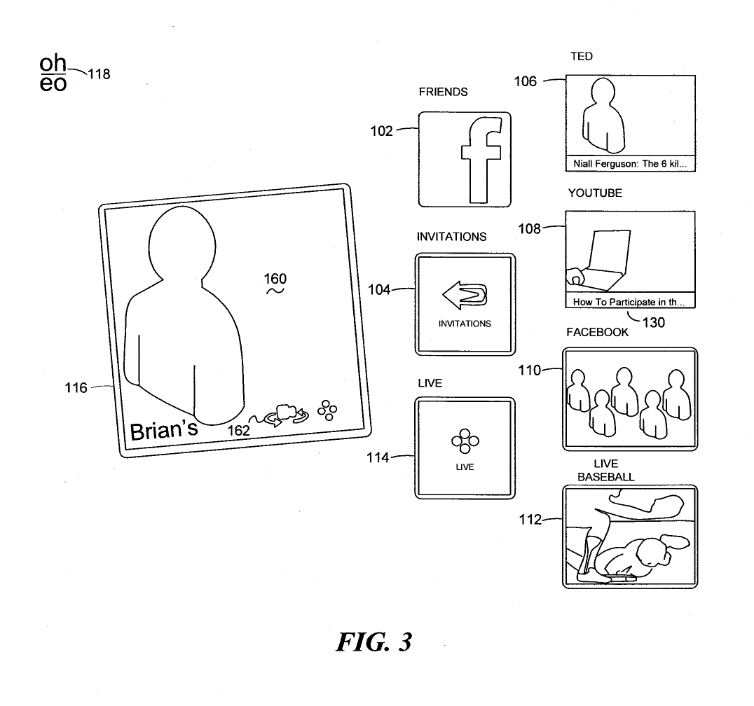

In certain embodiments, the GUI 100 includes an experience participant block 116. The experience block 116 is typically associated with a local active account and/or participant, e.g., the user logged into the GUI 100 and presumably operating the computer system. The experience block 116 has at least two states—a first state shown in FIG. 1 and a second state shown in FIG. 3. In this example, the first state 116 includes an avatar 150 associated with the local active account, a camera control button 152 for enabling the computer system camera, and an account button 154 for accessing information about the local active account. The second state 116 includes live video obtained locally, and a camera view selection button 162.

According to some embodiments, the GUI 100 provides at least two different environments. The first environment can be understood as an “explore” environment, where the local participant has access to a variety of display stacks and other functionality that facilitate activity such as exploring, searching and initiating different content, applications, and social networking. The second environment can be understood as an “experience” environment, where the local participant has initiated or joined into a particular experience such as an experience event. In each environment, different functionality is typically available.

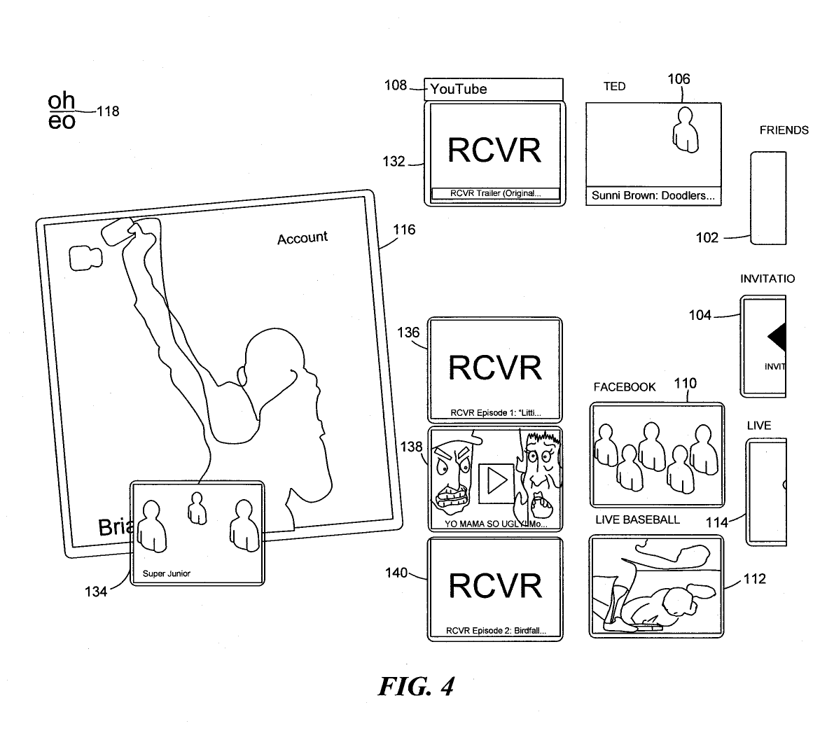

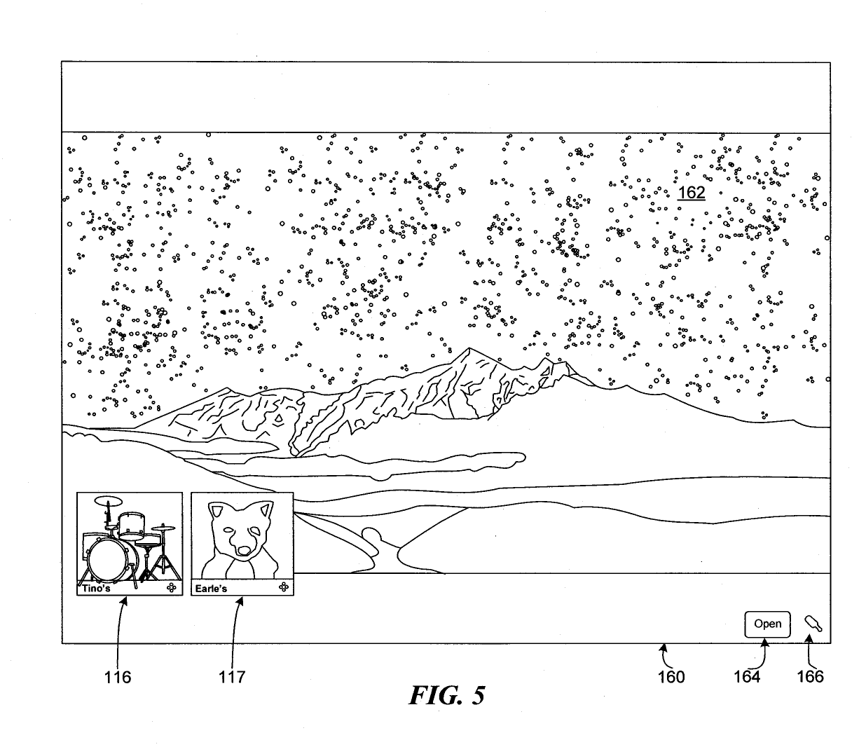

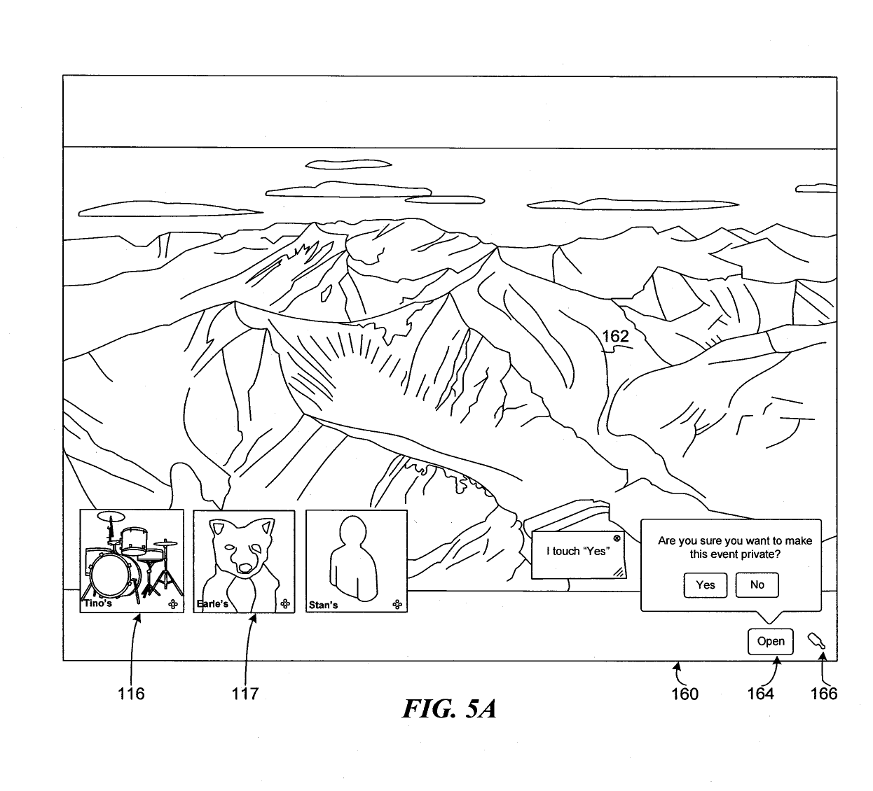

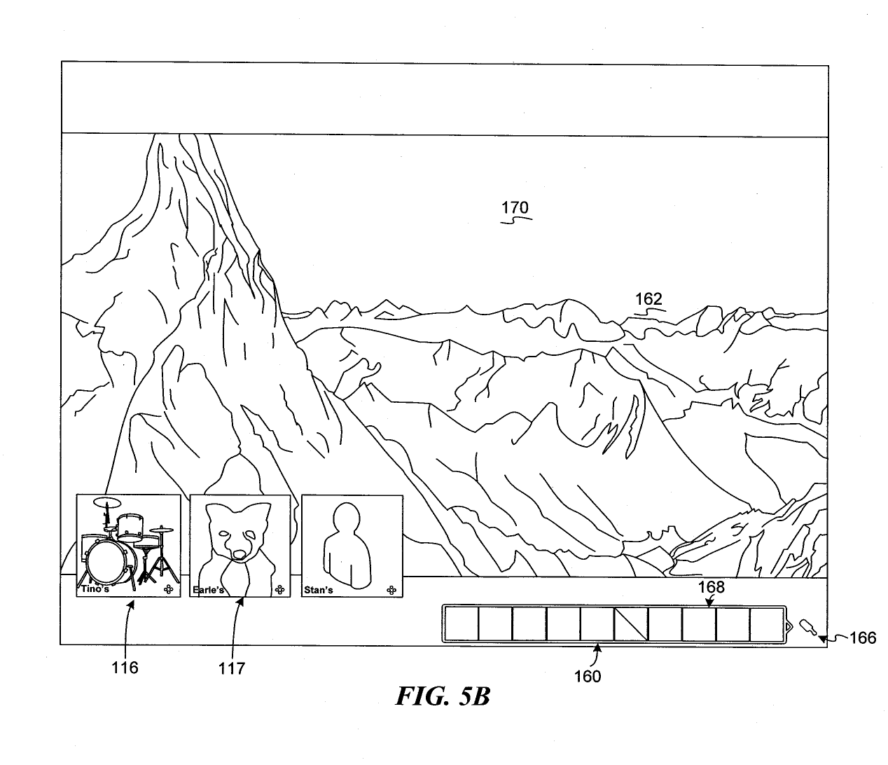

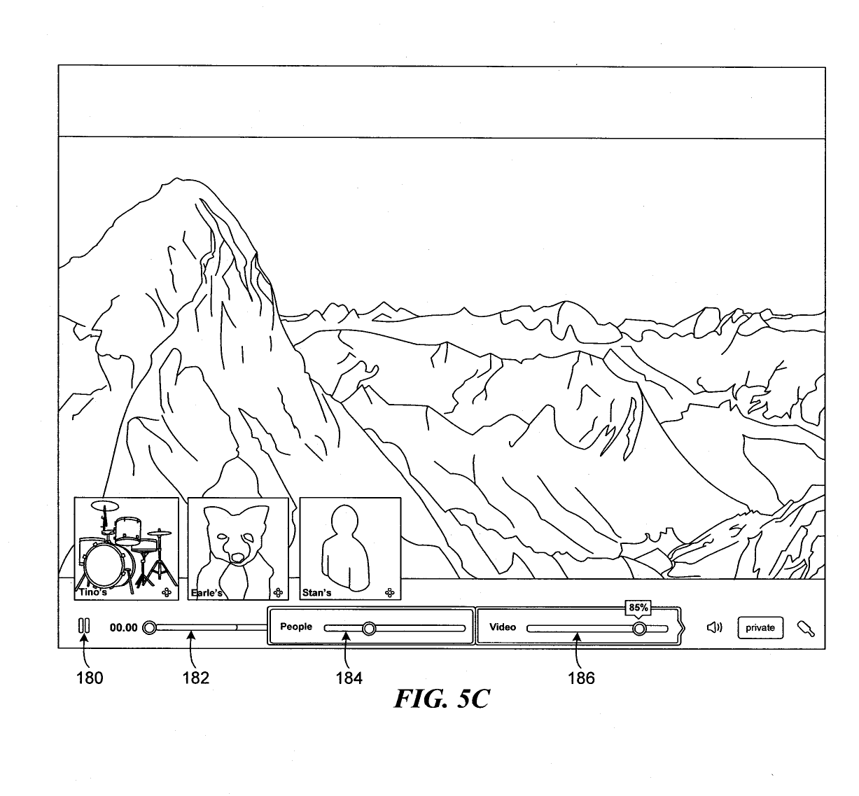

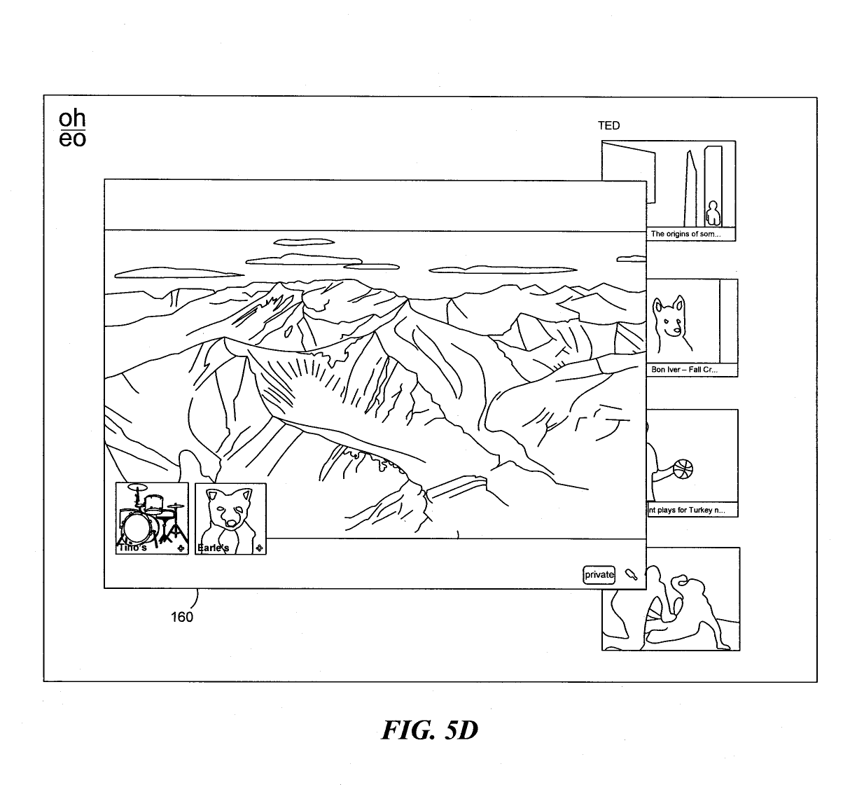

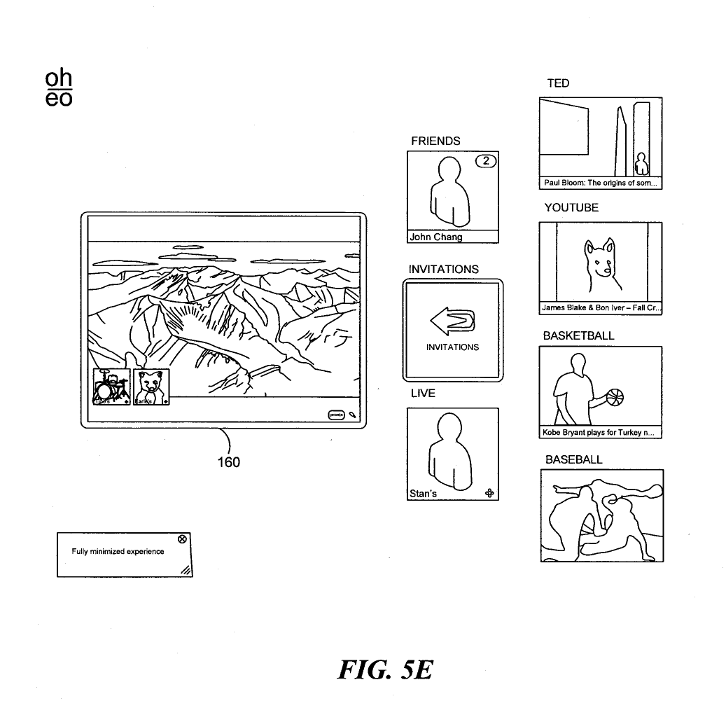

Turning next to FIG. 4, a first mechanism for moving from the explore environment and initiating an experience event will now be described. FIG. 4 illustrates the video stack 108 in an expanded state. Here the display block 134 has been selected and drug over to the participant block 116. Note that the display block 134 has transformed into a translucent state while being drug to indicate an active or selected state. Once the display block 134 is dropped into the participant block 116, an “experience event” associated with the content of the display block 134 can initiate within the participant block 116. In this specific case, the experience event begins with a YouTube® video playing as a background layer together with the participant block 116, as shown in FIG. 5. FIG. 5 illustrates an active event display block 160 which is expanded to fully occupy the available display space. This expansion could be done manually, or may be an immediate reaction to the initiation of an event.

While video is used as an example here, it will be appreciated that the content could correspond to any variety of operations including opening up a webpage with the block 116, launching an application, etc. The converse of this “drag to initiate” operation can be implemented as well. For example, an event may be terminated by dragging the relevant GUI element out of the participant block 116. This termination could affect the local user and/or any invitees that are participating in this event, really depending upon the nature of the event.

When an event is initiated and/or joined by the local participant, through dragging or other action, the active event display block 160 is created. As shown in FIG. 5, the event block 160 includes the participant block 116, a video layer 162, and another contact/friend block 117. As will be described in more detail below, the GUI 100 facilitates inclusion of friends and contacts into events.

In certain embodiments, within the experience environment of the event block 160 the available controls and their respected display and means of engagement are intentionally selected and/or designed to not distract from the experience. This can be accomplished in a variety of ways. For example, a variety of tools and controls such as play, scrub, volume, etc., are not shown whatsoever in a certain situations such as the embodiment of FIG. 5, and may only show when the participant touches the screen or in some other way requests their presence. These controls may remain visibly active for a predefined period of time, e.g. 5 seconds, or may stay visibly active until the participant takes a specific action, such as touching the screen again, or until a control input occurs. In the state of FIG. 5, a privacy setting button 164 and a drawing tool button 166 are displayed. The privacy setting button 164 indicates the event is in an open state. Selecting the button 164 enables the participant to change the state of the event to private, for example, a situation that all the desired participants have joined the event as seen in FIG. 5A.

FIG. 5B illustrates an event block 160 where the local participant, perhaps represented by a display block 116, has selected a drawing tool 166 initiating a “chalk talk” tool with a color palate interface 168. The chalk talk application provides a drawing layer 170 within the event block 160. Within the drawing layer 170, the local participant is providing a drawing tool and can select the color via the color palate interface 168. The specific type of drawing tool (brush, pencil, etc) may also be selectable. The GUI 100 implements the drawing layer 170 such that each user participating in the event can draw with their desired color. As shown in FIG. 5B, each display block can be implemented with a colored border, colored translucent bar, or some other suitable indicator, matching the color selected by each participant via the color palate interface. That way, it is perhaps apparent by matching the colors which participant has drawn or is drawing what. A double-tap on the screen or some other suitable command can map to an erase command.

FIG. 5C illustrates an event block 160 where the local participant has engaged further tools for controlling the experience environment. In particular, the event block 160 presents a play/pause button 180, a video slider bar and play indicator 182, a participant volume control slider bar 184, and a video volume control slider bar 186. Note that each separate layer of content or related layer of content could have unique controls. For example, an experience could involve a live video layer and a live commentary layer, each with their specific play and volume controls. Also, other controls like coupling display block sizing to display block volume could additionally be available within an experience. Finally, FIGS. 5D-5E illustrate an event block 160 in an active state being resized from a fully expanded state to a minimized state. This transition could be controlled by the local participant, or could be part of the experience, or could be triggered by some other activity.

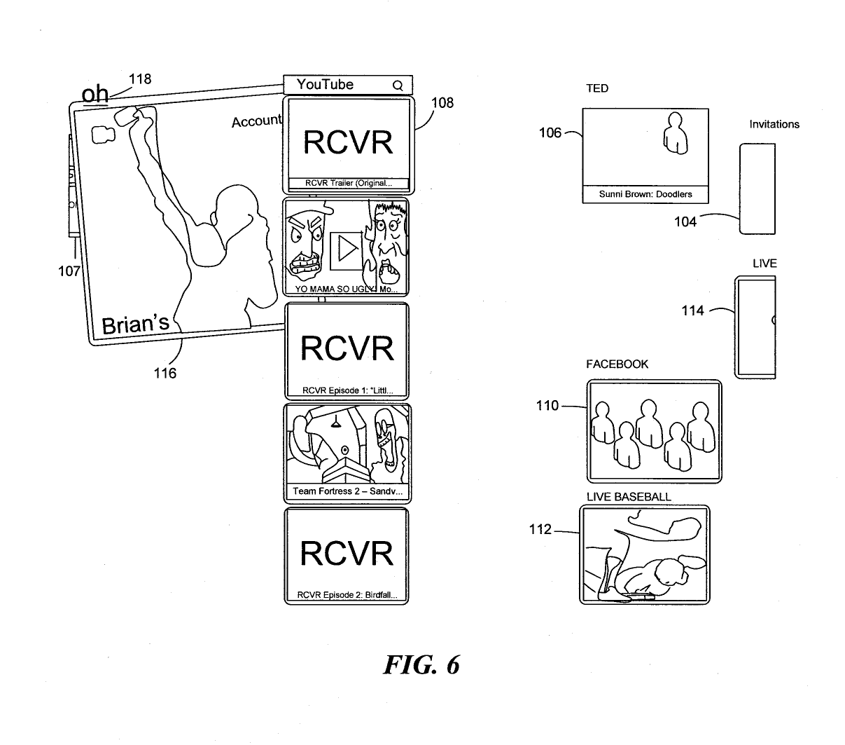

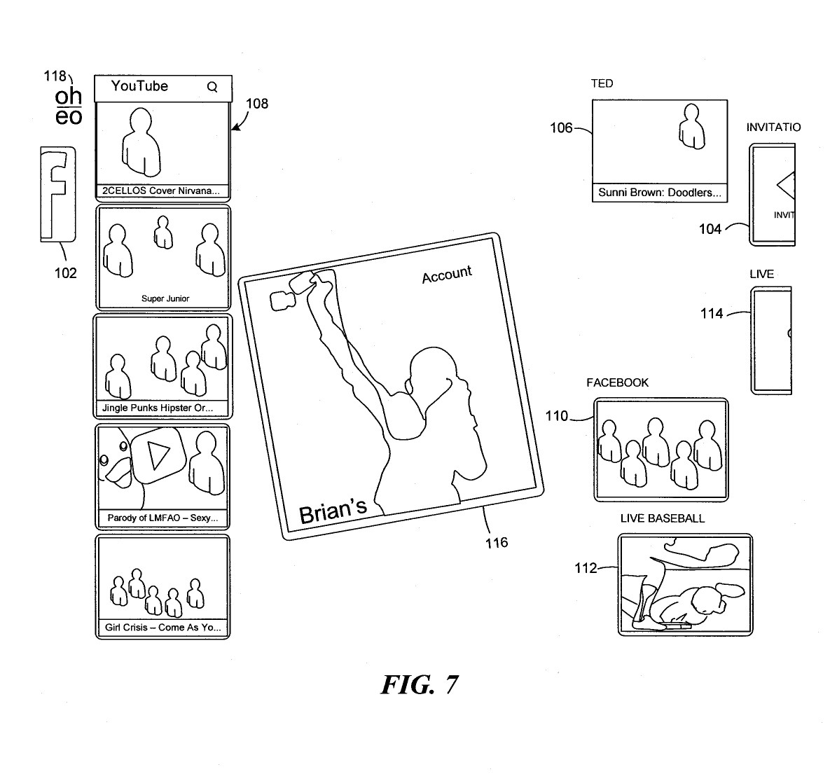

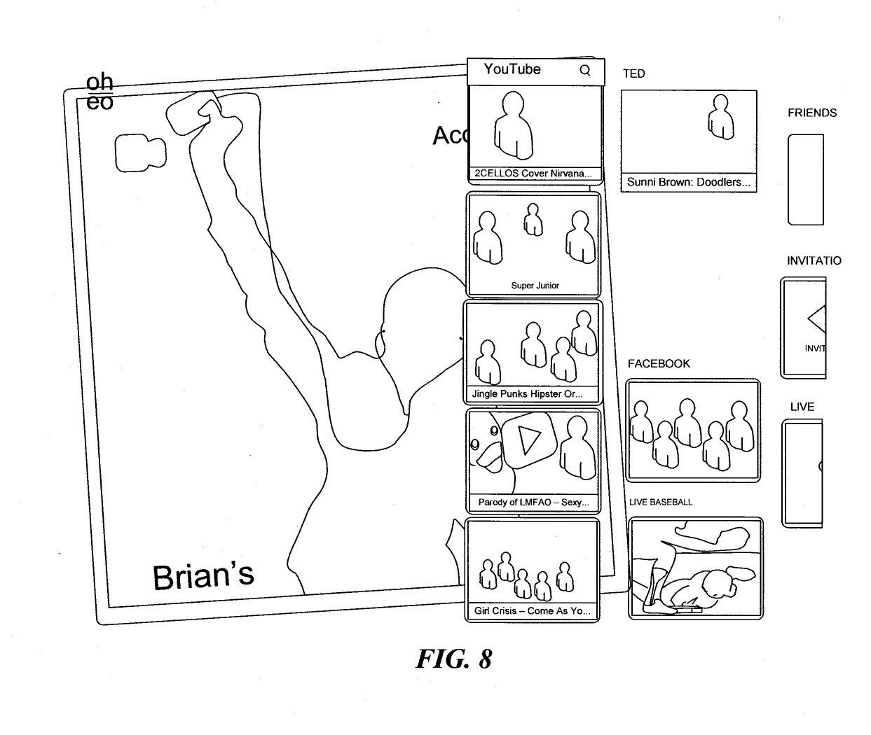

FIGS. 6-7 show another example of rearranging the elements of the GUI 100. In FIG. 6, the local participant has rearranged the elements in a manner not particularly conducive for interacting, as the participant block 116 is substantially covering one or more elements, and a video stack 108 is partially covering the participant block 116, yet there is quite a bit of “blank” space within the GUI 100. FIG. 7 illustrates the same elements arranged in a manner which may be more conducive to usability. This rearrangement of elements could occur automatically, perhaps due to a user setting. Alternatively, it is contemplated that the oheo button 118 could initiate rearrangement, either to a better arranged state as close as possible to the arrangement just prior, or to a default arrangement which could include sizing etc. One could imaging an initial selection of the oheo button 118 could rearrange into a first setting, while an second selection could then rearrange into the default arrangement, and even a third selection could result in resizing elements to default, collapsing all stacks, etc. For example, FIG. 8 shows a significantly enlarged participant block 116, with a “messy” arrangement of other elements. Selecting the oheo button 118 appropriately could result in the elements being resized, collapsed and rearranged back into a default arrangement and state, such as an arrangement of the GUI 100 as show in FIG. 1.

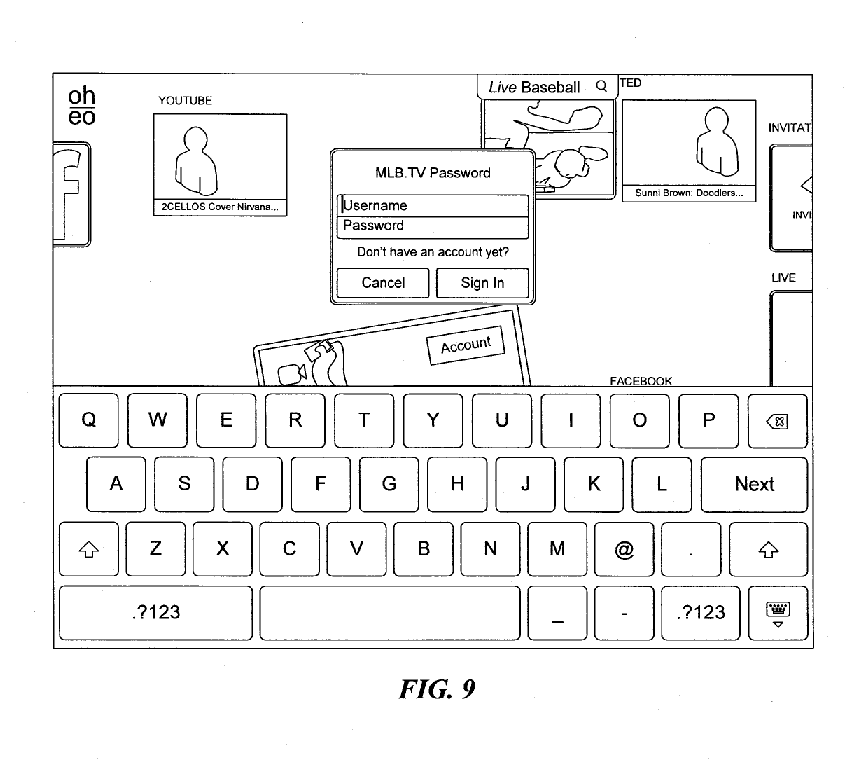

In some embodiments, initiating an event experience requires additional action beyond dragging a display block into the experience block. FIG. 9 illustrates a possible response to dragging an MLB display block 112 into the participant experience block. Specifically, as MLB TV is a members' only site, the initiating participant must sign in with a valid account—the possibility of creating an account is available. Depending upon licensing issues etc., this sign in requirement could be true for other contacts invited to join a related event. Thus accepting an invitation and/or joining an event, could require sign in by the new attendees.

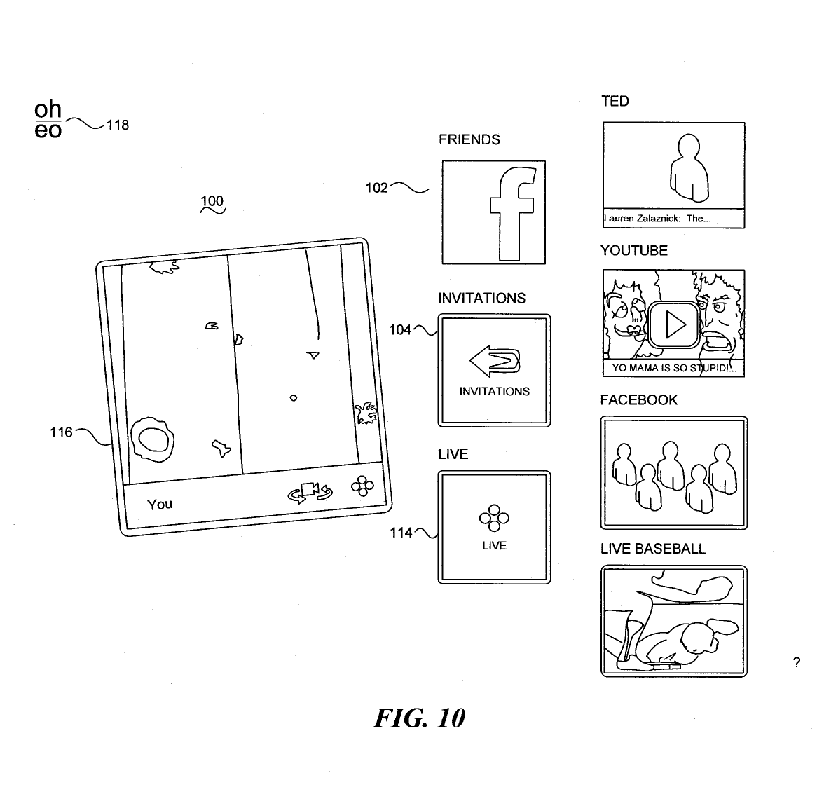

FIGS. 10-16 are now used to illustrate some capabilities of a contact stack 102, an invitation stack 104, and a live stack 114, as well as their interoperability with each other and other elements of a GUI 100 according to one embodiment. Some embodiments provide mechanisms for connecting with social contacts, inviting friends and/or contacts to participate in events, joining events (public and/or by invitation), initiating events, etc.

In FIG. 10, the contact stack 102, the invitation stack 104, and the live stack 114 are each in a collapsed state, and provide a neutral display indication. That is, no particular further information is indicated by the stacks in this state. In some embodiments, this neutral state indicates that there are no friend requests (received and/or outstanding), no pending invitations (received and/or outstanding), and no live events we may join (public or private). However, in other embodiments the collapsed state is always neutral, e.g., there is no further particular information to be found in the display.

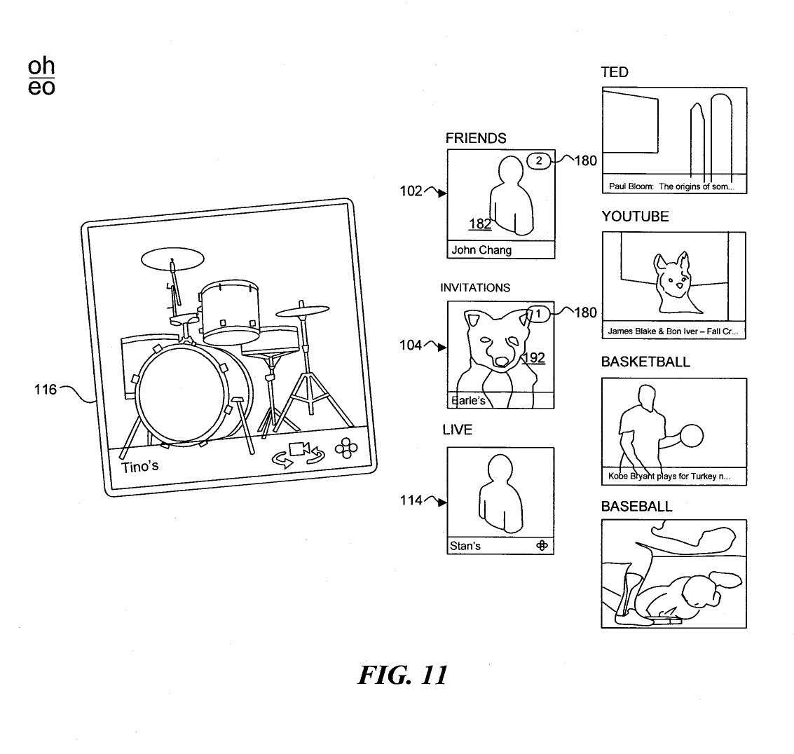

In contrast, FIG. 11 illustrates a situation where further information is available in these three stacks. The contact stack 102 indicates at icon 180 that two friend requests are pending, and an image 182 indicates that one of the pending friend requests relates to “John Cheng.” The invitation stack 104 indicates at icon 190 that there is one invitation pending, and an image 192 indicates that the invitation relates to “Earle.” The live stack 114 indicates that there is at least (or only, depending upon the rule) one live event which the local participant can join, and that this event is hosted or initiated by “Stan.” Note that the live stack 114 doesn't present an icon corresponding to the number of live events available to the local participant. This is intended to highlight the arbitrary nature of arranging the interface, i.e., that different embodiments can present the stacks and provide different functionality as desired by the application. The lack of an icon could specifically indicate there is only one available event to join, or could simply mean no such information is displayed. Furthermore, actions like the pending friend invitations could be invitations initiated by the local participant, invitations received by the local participant, or both. The same is true for the other stacks.

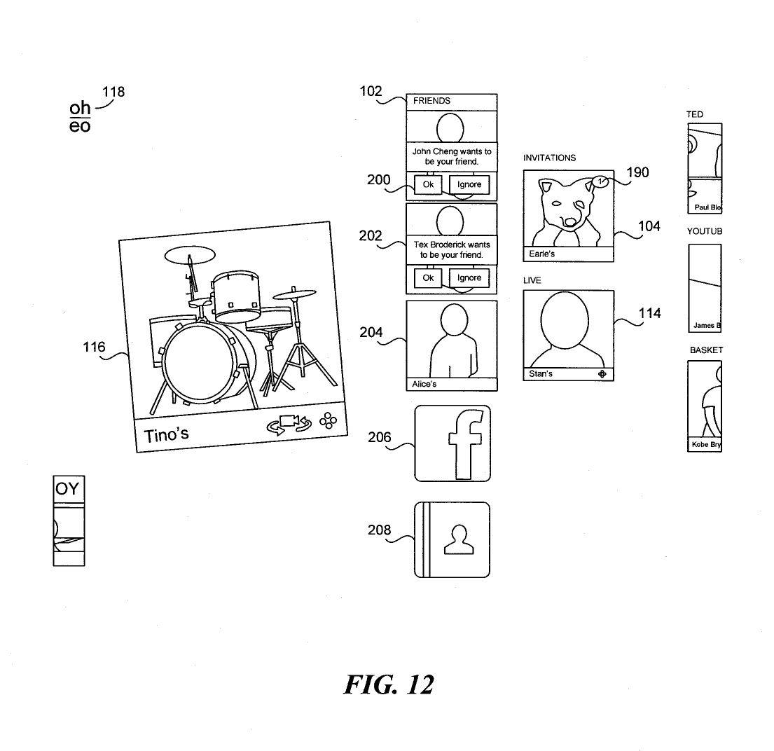

In FIG. 12, the contact stack 102 has been selected and in response has transitioned into an expanded state. (As an aside, note that the elements of the GUI 100 have disposed themselves into an arrangement more conducive to interaction.) The contact stack 102 here has display blocks 200-208. Display blocks 200 and 202 indicate that “John Chang” and “Tex Broderick,” respectively, want to connect as friends. Display block 204 indicates that “Alice” is already a connected friend. Display blocks 206 and 208 indicate two social networking sites (e.g., Facebook® or Linkedln®) are accessible for inviting friends into Oheo™, one of the applicant's experience platforms associated with the GUI 100.

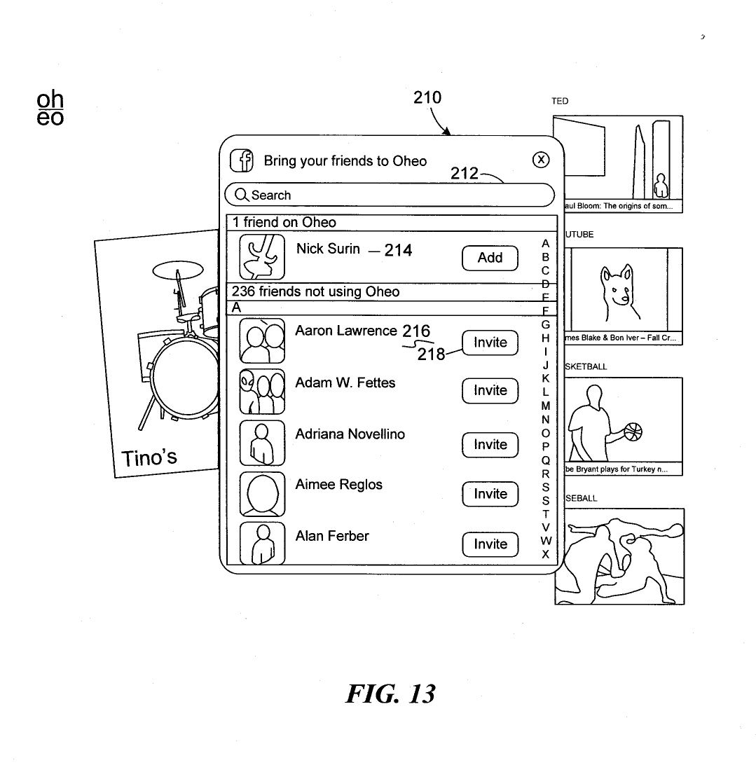

In FIG. 13, display block 208 corresponding to a Facebook account has been selected and in response a display block 210 has expanded and become active. The display block 210 could take any suitable form, in FIG. 13 it provides a search bar 212, a list 214 of friends already on Oheo, and an alphabetical and scrollable selection window 216, where each friend has an image, text and invite button 218, associated therewith.

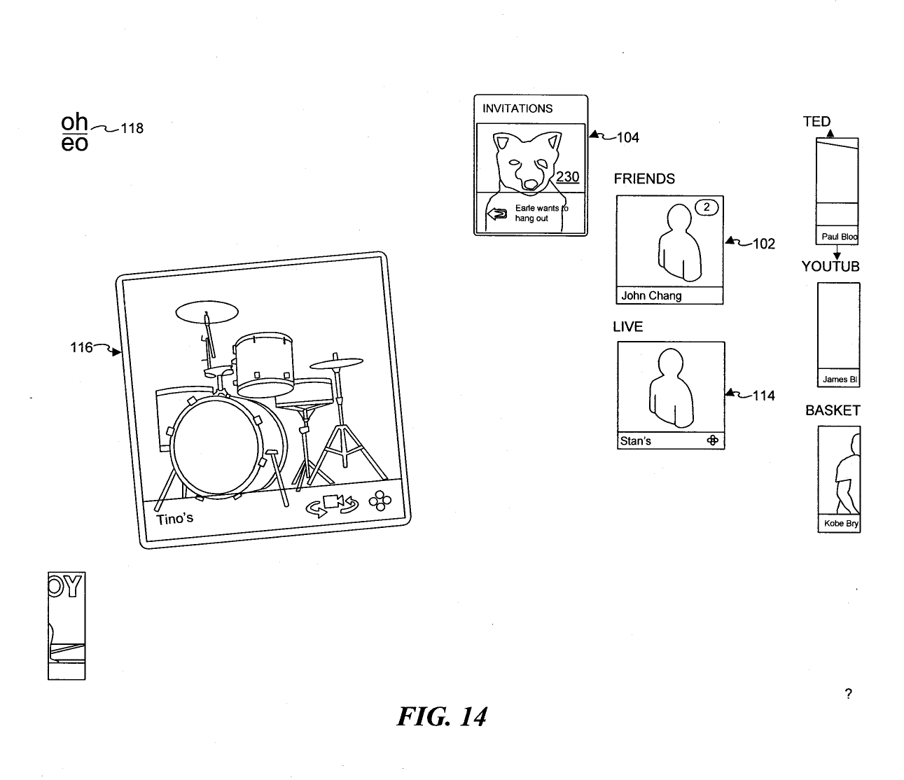

In FIG. 14, invite stack 104 has been selected and in response has transitioned to an expanded state. (Again, elements have rearranged accordingly.) In the expanded state of invite stack 104, a display block 230 indicates that “Earle wants to hang out” which in one embodiment means Earle is inviting the local active participant to join in an event, which may either be currently pending, may be scheduled for a future preset time, or may only be initiated upon a certain set of conditions arising—e.g., an invitee joining accepting an invitation.

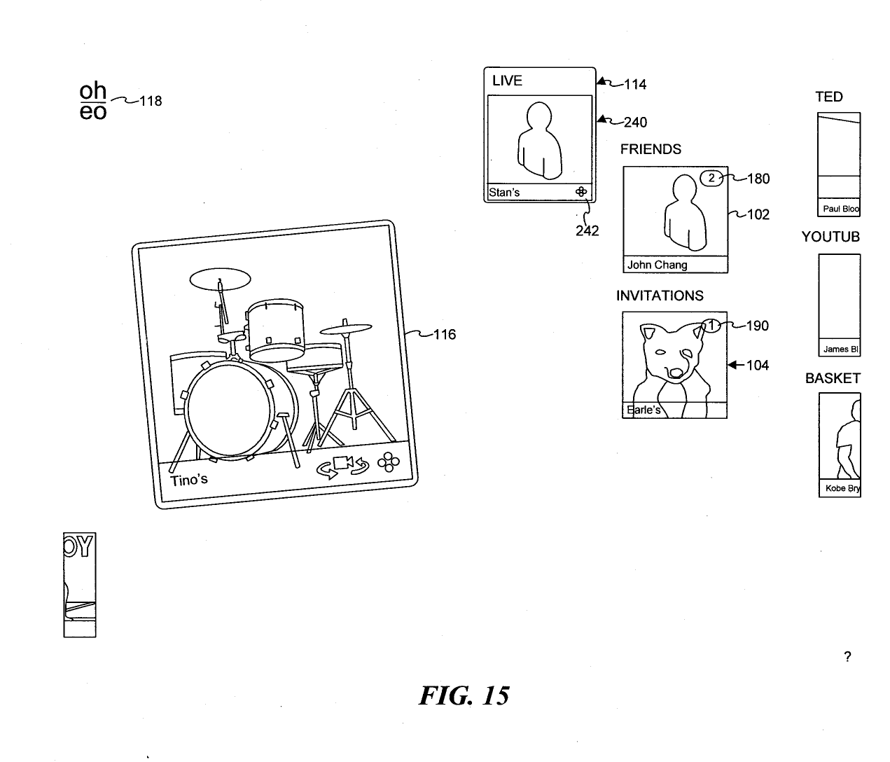

In FIG. 15, live stack 114 has been selected and in response has transitioned to an expanded state. (Again, elements have rearranged accordingly.) In the expanded state of live stack 114, a single event is available and shown as a display block 240 indicating an event initiated by “Stan” is available to the local user. Also in the display block 240 is a spin icon 242 which indicates some characteristic of “Stan's” event. In this instance particularly, the spin icon 242 is green, indicating an event that is open to friends. Other colors and or shapes may indicate different aspects, such as private or invitation only, public events, pay per view events (say, a $$ symbol), specific membership required to participate (say, an MLB logo), etc. Note that such symbols could also be available on other invitations, notices, display blocks, etc.

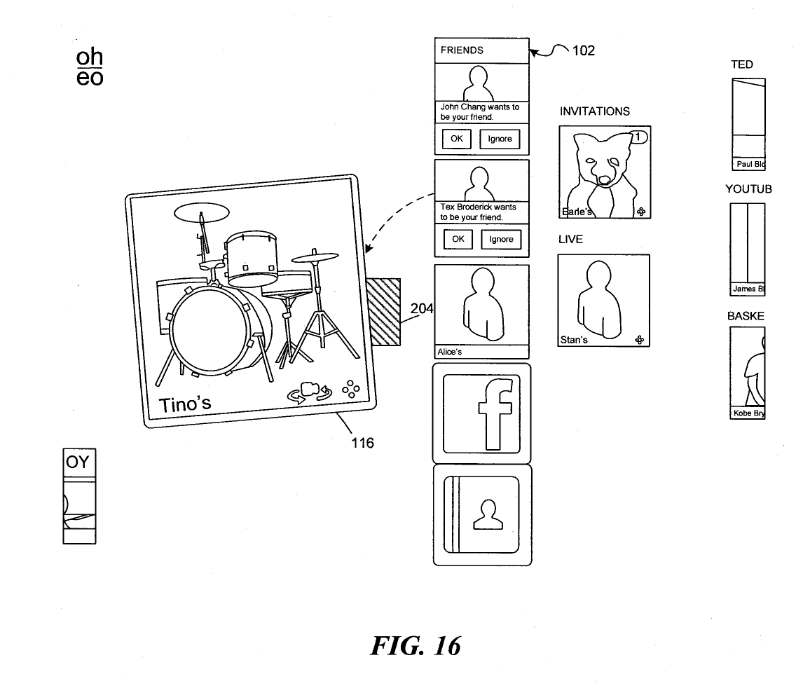

FIG. 16 is now used to illustrate one mechanism for inviting friends and/or contacts to join in an experience event. In FIG. 16 the contact stack 102 is shown in an expanded state with a plurality of contact display blocks such as contact block 200. A local participant can select and drop the contact block 204 within the local event experience block 116. This action triggers an invitation to the contact or friend associated with the contact block 200 to join in an active (or scheduled) experience. In some embodiments, the selection and dragging process would place the contact block 200 into a translucent state to indicate actively selected.

By comparing the miscellaneous view present above, it is apparent that the applicant's GUI 100 has rearranged the elements of the interface to accommodate for each action along the way resulting in the expanded state of the invitation stack 104. Typically the GUI 100 would rearrange elements in a logical fashion to improve usability. For example, selecting and expanding the invitation stack 104 tends to indicate this element should be displayed prominently, as well as any other stacks and/or blocks that might be related to event invitations, or whatever makes the best sense in the specific circumstances. Other situations may result in an expanded stack collapsing under suitable conditions. For example, initiating an application through an application block from expanded application stack may result in the application stack collapsing once the application is started--presumably, the user has the desired application so the stack can collapse. This behavior could of course be controlled or influenced by settings in the local user account.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

I claim:

1. A computer implemented method for providing a graphical user interface for a computer system, the method comprising:
generating an experience block corresponding to a local active account, the experience block having at least a first state and a second state;
switching display states of the experience block, in response to input controls received at the graphical user interface, wherein:
when the experience block is in the first state, the experience block includes video generated by a camera associated with the computer system in real time;
when the experience block is in the second state, the experience block includes a first avatar associated with the local active account;
sizing the experience block according to input controls received at the graphical user interface;
generating a first display stack, the first display stack including a first plurality of display blocks corresponding to content, the first display stack having a collapsed state and an expanded state;
switching display states of the first display stack, in response to input controls received at the graphical user interface, wherein:
when the first display stack is in the collapsed state, a collapsed state image is displayed which is minimized in size and does not display all the first plurality of display blocks, and provides a visual clue that content is available within the first display stack;
when the first display stack is in the expanded state, an expanded state image is displayed which includes images associated with each of the first plurality of display blocks.

2. A computer implemented method for providing a graphical user interface for a computer system as recited in claim 1, wherein the computer system includes a touch screen, wherein the experience block responds to a touch selection by switching between the first state and the second state.

3. A computer implemented method for providing a graphical user interface for a computer system as recited in claim 1, wherein the first avatar is programmable via the local active account.

4. A computer implemented method as recited in claim 1, wherein a first volume associated with content within the experience block is proportional to size of the experience block, whereby sizing the experience block controls both a size of the experience block and a magnitude of the first volume.

5. A computer implemented method as recited in claim 1, further comprising:
generating and displaying a plurality of display stacks on the computer system, wherein: the first display stack represents video content and each of the first plurality of display blocks corresponds to a specific video; a second display stack represents a collection of friends of the local active account, and each of a second plurality of display blocks corresponds to a specific friend; and a third display stack represents a collection of pending event invitations, and each of a third plurality of display blocks corresponds to a specific invitation.

6. A computer implemented method as recited in claim 1, wherein the first display stack represents video content and each of the first plurality of display blocks corresponds to a specific video.

7. A computer implemented method as recited in claim 1, wherein the first display stack represents a collection of friends of the local active account, and each of the first plurality of display blocks corresponds to a specific friend.

8. A computer implemented method as recited in claim 1, wherein the first display stack represents a collection of pending experience invitations, and each of the first plurality of display blocks corresponds to a specific invitation.

9. A computer implemented method as recited in claim 1, wherein the first display stack represents a collection of devices, and each of the first plurality of display blocks corresponds to a specific device.

10. A computer implemented method as recited in claim 1, wherein the first display stack represents a collection of application available for execution on the computer system, and each of the first plurality of display blocks corresponds to a specific application.

11. A computer implemented method as recited in claim 1, wherein the first display stack represents a collection of photographs, and each of the first plurality of display blocks corresponds to a specific photograph.

12. A computer implemented method as recited in claim 1, wherein the first display stack represents a collection of websites, and each of the first plurality of display blocks corresponds to a specific website.

13. A computer implemented method as recited in claim 1, wherein when the first display stack is in the expanded state, the method further comprises:
enabling a specific display block to be selected and moved; and
initiating a first experience within the experience block in response to the specific display block being selected and moved into the experience block, the first experience correlated to content associated with the specific display block.

14. A computer implemented method as recited in claim 13, further comprising:
terminating the first experience, at least locally, in response to the specific display block, or an associated representation thereof, being moved out of the experience block.

15. A computer implemented method as recited in claim 13, the method further comprising:
generating and displaying a second display stack, the second display stack including a second plurality of display blocks, each display block corresponding to a contact;
responding, to a given display block from the second plurality of display blocks being selected and moved into the experience block, by inviting a given contact associated with the given display block to join in the first experience.

16. A computer implemented method as recited in claim 15, the method further comprising:
responding to the given contact accepting the first experience invitation by bring the given contact into the experience, including displaying a given display block representative of the given contact within the experience block.

17. A computer implemented method as recited in claim 15, the method further comprising:
responding to the given display block being selected and moved out of the experience block by ending the given contact's participation in the first experience.

18. A computer implemented method as recited in claim 15, the method further comprising:
sizing the given display block according to input controls received at the graphical user interface;
wherein a first volume associated with audio content associated with the experience block is proportional to size of the experience block, whereby sizing the experience block controls both size of and volume magnitude associated with the experience block; and
wherein a second volume associated with audio content associated with the given display block is proportional to size of the given display block, whereby sizing the given display block controls both size of and volume magnitude associated with the given display block.

19. A computer implemented method for providing a graphical user interface for a computer system, the method comprising:
generating and displaying a plurality of display stacks, wherein each specific display stack includes a plurality of display blocks, the specific display stack has a collapsed state and an expanded state, wherein when the specific display stack is in the collapsed state, a collapsed state image is displayed minimized in size and does not display all the plurality of display blocks, and the collapsed state image provides a visual clue that content is available for expansion within the specific display stack, and when the specific display stack is in the expanded state, an expanded state image is displayed which includes images associated with each of the plurality of display blocks;
switching display states of each display stack, in response to input controls received at the graphical user interface;
providing a first display stack representing video content where each display block corresponds to a specific video;
providing a second display stack representing a plurality of contacts where each display block corresponds to a specific friend;
providing a third display stack representing a plurality of event invitations where each display block corresponds to a specific invitation.

20. A computer implemented method as recited in claim 19, further comprising:
coupling the first display stack with searchable content;
providing a search tool associated with the first display stack;
receiving a search request via the search tool;
presenting search results as display blocks within the first display stack.

21. A graphical user interface for controlling a computer system, the graphical user interface comprising:
a plurality of display stacks, wherein each specific display stack includes a plurality of display blocks, the specific display stack has a collapsed state and an expanded state, wherein when the specific display stack is in the collapsed state, a collapsed state image is displayed minimized in size and does not display all the plurality of display blocks, and the collapsed state image provides a visual clue that content is available for expansion within the specific display stack, and when the specific display stack is in the expanded state, an expanded state image is displayed which includes images associated with each of the plurality of display blocks;
means for switching display states of each display stack, in response to input controls received at the graphical user interface;
a first display stack representing video content where each display block corresponds to a specific video;
a second display stack representing a plurality of contacts where each display block corresponds to a specific friend;
a third display stack representing a plurality of event invitations where each display block corresponds to a specific invitation.

22. A computer system comprising:
a processing unit:
memory;
a network device;
a bus coupling the processing unit, the memory and the network device;
a first module for generating a first display block corresponding to a local active account, the first display block having at least a first state and a second state;
a second module for switching display states of the first display block, in response to input controls received at the graphical user interface, wherein:
when the first display block is in the first state, the first display block includes video generated by a camera associated with the computer system in real time;
when the first display block is in the second state, the first display block includes a first avatar associated with the local active account;
a third module for sizing the first display block according to input controls received at the graphical user interface;
a fourth module for generating a first display stack, the first display stack including a first plurality of display blocks corresponding to content, the first display stack having a collapsed state and an expanded state;
a fifth module for switching display states of the first display stack, in response to input controls received at the graphical user interface, wherein:
when the first display stack is in the collapsed state, a collapsed state image is displayed which is minimized in size and does not display all the first plurality of display blocks, and provides a visual clue that content is available within the first display stack;
when the first display stack is in the expanded state, an expanded state image is displayed which includes images associated with each of the first plurality of display blocks.

23. A machine for providing a graphical user interface for a computer system, the method comprising:
means for generating and displaying a plurality of display stacks, wherein each specific display stack includes a plurality of display blocks, the specific display stack has a collapsed state and an expanded state, wherein when the specific display stack is in the collapsed state, a collapsed state image is displayed minimized in size and does not display all the plurality of display blocks, and the collapsed state image provides a visual clue that content is available for expansion within the specific display stack, and when the specific display stack is in the expanded state, an expanded state image is displayed which includes images associated with each of the plurality of display blocks;
means for switching display states of each display stack, in response to input controls received at the graphical user interface;
means for providing a first display stack representing video content where each display block corresponds to a specific video;
means for providing a second display stack representing a plurality of contacts where each display block corresponds to a specific friend;
means for providing a third display stack representing a plurality of event invitations where each display block corresponds to a specific invitation.

24. A system for providing a graphical user interface for a computer system, the system comprising:
means for generating an experience block corresponding to a local active account, the experience block having at least a first state and a second state;
means for switching display states of the experience block, in response to input controls received at the graphical user interface, wherein:
when the experience block is in the first state, the experience block includes video generated by a camera associated with the computer system in real time;
when the experience block is in the second state, the experience block includes a first avatar associated with the local active account;
means for sizing the experience block according to input controls received at the graphical user interface;
means for generating a first display stack, the first display stack including a first plurality of display blocks corresponding to content, the first display stack having a collapsed state and an expanded state;
means for switching display states of the first display stack, in response to input controls received at the graphical user interface, wherein:
when the first display stack is in the collapsed state, a collapsed state image is displayed which is minimized in size and does not display all the first plurality of display blocks, and provides a visual clue that content is available within the first display stack;
when the first display stack is in the expanded state, an expanded state image is displayed which includes images associated with each of the first plurality of display blocks.

25. A system as recited in claim 24, wherein the computer system includes a touch screen, wherein the experience block responds to a touch selection by switching between the first state and the second state.

26. A system as recited in claim 24, wherein the first avatar is programmable via the local active account.

27. A system as recited in claim 24, wherein a first volume associated with content within the experience block is proportional to size of the experience block, whereby sizing the experience block controls both a size of the experience block and a magnitude of the first volume.

28. A system as recited in claim 24, further comprising:
means for generating and displaying a plurality of display stacks on the computer system, wherein: the first display stack represents video content and each of the first plurality of display blocks corresponds to a specific video; a second display stack represents a collection of friends of the local active account, and each of a second plurality of display blocks corresponds to a specific friend; and a third display stack represents a collection of pending event invitations, and each of a third plurality of display blocks corresponds to a specific invitation.

29. A system as recited in claim 24, wherein the first display stack represents video content and each of the first plurality of display blocks corresponds to a specific video.

30. A system as recited in claim 24, wherein the first display stack represents a collection of friends of the local active account, and each of the first plurality of display blocks corresponds to a specific friend.

31. A system as recited in claim 24, wherein the first display stack represents a collection of pending experience invitations, and each of the first plurality of display blocks corresponds to a specific invitation.

32. A system as recited in claim 24, wherein the first display stack represents a collection of devices, and each of the first plurality of display blocks corresponds to a specific device.

33. A system as recited in claim 24, wherein the first display stack represents a collection of application available for execution on the computer system, and each of the first plurality of display blocks corresponds to a specific application.

34. A system as recited in claim 24, wherein the first display stack represents a collection of photographs, and each of the first plurality of display blocks corresponds to a specific photograph.

35. A system as recited in claim 24, wherein the first display stack represents a collection of websites, and each of the first plurality of display blocks corresponds to a specific website.

36. A system as recited in claim 24, wherein when the first display stack is in the expanded state, the system further comprising:
means for enabling a specific display block to be selected and moved; and
means for initiating a first experience within the experience block in response to the specific display block being selected and moved into the experience block, the first experience correlated to content associated with the specific display block.

37. A systems as recited in claim 36, further comprising:
means for terminating the first experience, at least locally, in response to the specific display block, or an associated representation thereof, being moved out of the experience block.

38. A system as recited in claim 36, the system further comprising:
means for generating and displaying a second display stack, the second display stack including a second plurality of display blocks, each display block corresponding to a contact;
means for responding, to a given display block from the second plurality of display blocks being selected and moved into the experience block, by inviting a given contact associated with the given display block to join in the first experience.

39. A system as recited in claim 38, the system further comprising:
means for responding to the given contact accepting the first experience invitation by bring the given contact into the experience, including displaying a given display block representative of the given contact within the experience block.

40. A system as recited in claim 24, the system further comprising:
means for responding to the given display block being selected and moved out of the experience block by ending the given contact's participation in the first experience.

41. A system as recited in claim 24, the system further comprising:
means for sizing the given display block according to input controls received at the graphical user interface;
wherein a first volume associated with audio content associated with the experience block is proportional to size of the experience block, whereby sizing the experience block controls both size of and volume magnitude associated with the experience block; and
wherein a second volume associated with audio content associated with the given display block is proportional to size of the given display block, whereby sizing the given display block controls both size of and volume magnitude associated with the given display block.
